(19) United States
(12) Patent Application Publication
(10) Pub. No.: US 2008/0260541 A1
(43) Pub. Date: Oct. 23, 2008

(54) Induction Motor Control

(75) Inventors: Alexander Lifson, Manlius, NY (US); Michael F. Taras, Fayetteville, NY (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: Carrier Corporation, Farmington, CT (US)

(21) Appl. No.: 11/886,048

(22) PCT Filed: Mar. 30, 2005
(86) PCT No.: PCT/US05/10818

§ 371 Date: Sep. 10, 2007

(51) Int. Cl. F04B 49/06; H02P 23/08

(52) U.S. Cl. 417/44.11; 318/799

(57) ABSTRACT

The operation of an AC induction motor 24 is controlled in response to the actual slip exhibited by the motor during operation. The slip of the motor 24 may be determined by determining the actual running speed, n, of the motor shaft 25A, measuring the line frequency, nₛ, of the electricity supplied to the motor, and calculating the slip, S, of the motor using the relationship: S=((nₛ−n)/nₛ)*100. If the slip is too high when compared to a predetermined maximum acceptable slip, corrective action is taken to decrease the loading on the motor. If the slip is too low when compared to a predetermined minimum acceptable slip, corrective action is taken to increase the loading on the motor. By adjusting the operation of the system by appropriately changing the load on the motor, or changing the electrical supply parameters, the actual slip exhibited by the motor 24 is returned to a value within the range between the minimum acceptable slip and the maximum acceptable slip, thereby protecting the motor and improving overall reliability.

### TECHNICAL FIELD

The present invention relates generally to AC induction motors, and more particularly, to a method for controlling the operation of an AC induction motor when driving a load-bearing device, for example a compressor having a shaft driven in rotation by an AC induction motor.

### BACKGROUND OF THE INVENTION

In many industrial applications, load-bearing devices, for example, pumps, compressors, appliances and the like are driven by an electric motor, typically an AC induction motor. For example, in air conditioning and refrigeration systems, a compressor is provided to compress a refrigerant and pass that refrigerant through a refrigeration circuit and associated system components such as a condenser, an evaporator and an expansion device. The refrigerant, or other fluid, is compressed as it passes through compression elements associated with a compressor shaft driven in rotation by a drive motor. In conventional practice, these drive motors are commonly AC induction motors.

It is desirable, particularly in air conditioning and refrigeration applications, to operate the compressor within a specified range of loads to ensure efficient operation, to improve reliability and to extend the life of the compressor. If the compressor is too highly loaded, the drive motor may draw too much electric current in order to drive the compressor to meet the load demand, resulting in overheating of the motor or overloading other internal compressor components that may damage them or cause a motor protection device to shut the motor down. If the compressor is too lightly loaded, the drive motor or other internal compressor components may also overheat, particularly under conditions such as low suction pressure, due to too little fluid being pumped through the compressor to adequately cool the drive motor. Additionally, under the abovementioned conditions, compressor oil may loose its lubrication properties causing accelerated wear and seizure of moving compression elements.

To avoid the above mentioned problems, attempts have been made to control compressor operation by indirectly estimating the load on the motor and adjusting operation of the compressor in response thereto. In conventional practice, however, estimating the motor loading has required knowledge of various operating conditions, including the compressor suction pressure and suction temperature, the compressor discharge pressure, and the voltage being supplied to the drive motor. Therefore, to have reasonably good resolution of the motor load at least four sensors, namely two pressure transducers, one temperature transducer, and one voltage transducer, were required. As precise measurements of these parameters are required to achieve an accurate estimate of motor loading, duplicate sensors are often also needed to be installed to provide redundancy. Accordingly, this method of estimating motor strength is not only expensive due to the cost of the required sensors and associated controls, but also carries a relatively substantial level of uncertainty. Alternate methods of determining the motor loading by measuring various electric parameters, such as the current draw, the voltage level and power factor of the electricity supplied to the motor, or the voltage level and the electric power draw directly, also require a plurality of sensors and are expensive, especially in the case of three-phase motors.

### SUMMARY OF THE INVENTION

It is a general object of the present invention to control the operation of an AC induction motor in response to the slip exhibited by the AC induction motor in operation.

It is a further object of the present invention to control operation of a device driven by an AC induction motor in response to the slip of the AC induction motor when the device is under a load.

It is a particular object of the present invention to control operation of a compressor driven by an AC induction motor in response to the slip of the AC induction motor.

In one aspect, a method of operating an AC induction motor powered by electric current from an AC source is provided including the steps of determining the magnitude of the slip exhibited by the motor under load and taking corrective action to modify the motor operation based on the magnitude of the slip. Taking corrective action may include adjusting the load on the motor, adjusting the frequency of the electric current from the source powering the motor, or adjusting the voltage of the electric current from the AC source powering the motor. The step of determining the magnitude of the slip exhibited by the motor under load includes calculating the magnitude of the slip using the relationship: S=((nₛ−n)/nₛ)*100, where nₛ is the frequency of the AC source supplied to the motor, and n is actual running speed of the rotor shaft of the motor.

In another aspect, a method for controlling operation of a compressor driven by an AC induction motor is provided having the steps of determining the slip of the motor, and adjusting the loading on the compressor in response to the slip. The slip of the motor may be determined by determining the actual running speed, n, of the compressor drive shaft, measuring the frequency, nₛ, of the electric current supplied to the motor, and calculating the slip, S, of the AC induction motor using the relationship: S=((nₛ−n)/nₛ)*100. If the slip is too high when compared to a predetermined maximum acceptable value then a corrective action can be taken to decrease the loading on the compressor. If the slip is too low when compared to a predetermined minimum acceptable value then a corrective action can be taken to increase the loading on the compressor.

In a further aspect, there is provided a vapor compression system including a compressor having a driven shaft operatively associated with a compression mechanism wherein fluid is compressed upon rotation of the driven shaft, an AC induction motor operatively associated with the driven shaft for driving the driven shaft, a sensor operatively associated with the compressor for determining the magnitude of the slip exhibited by the motor when driving the driven shaft, and a controller operatively associated with the motor for taking corrective action to modify the motor operation based on the magnitude of the slip. The vapor compression system may include a sensor for determining the actual running speed of the drive shaft of the compressor and a sensor for measuring the frequency of the electric current from an AC source powering the motor. The compressor may be a single speed, multi-speed or variable speed compressor. The compressor may be a scroll compressor, a screw compressor, a rotary compressor, a centrifugal compressor, a reciprocating compressor, or any type of compressor having a shaft driven by an AC induction motor.

### DESCRIPTION OF THE DRAWINGS

For a further understanding of the present invention, reference should be made to the following detailed description of a preferred embodiment of the invention taken in conjunction with the accompanying drawings wherein:

FIG. 1 illustrates the schematic representation of a first exemplary embodiment of an air conditioning or refrigeration system;

FIG. 2 is an elevation view of a scroll compressor;

FIG. 3 is a schematic representation of second embodiment of a second exemplary embodiment of an air conditioning or refrigeration system;

FIG. 4 is a schematic representation of another embodiment of a third exemplary embodiment of an air conditioning or refrigeration system;

FIG. 5 is a schematic representation of another embodiment of a fourth exemplary embodiment of an air conditioning or refrigeration system;

FIG. 6 is a schematic representation of another embodiment of a fifth exemplary embodiment of an air conditioning or refrigeration system;

FIG. 7 is a schematic representation of another embodiment of a sixth exemplary embodiment of an air conditioning or refrigeration system;

FIG. 8 is a schematic representation of another embodiment of a seventh exemplary embodiment of an air conditioning or refrigeration system; and

FIG. 9 is a schematic representation of another embodiment of a eighth exemplary embodiment of an air conditioning or refrigeration system.

### DESCRIPTION OF THE PREFERRED EMBODIMENT

Referring now to FIG. 1, the present invention will be described herein with respect to a compressor installed in a vapor compression system, such as, for example, an air conditioning or refrigeration circuit. However, it should be understood that the refrigerant circuit is used for illustration of the proposed concept, and that this invention can be applied to any installation where an induction motor drives any other component under load, for example a pump, an appliance or other device. For a refrigerant circuit, such as commonly found in air conditioning or refrigeration systems, having a condenser 4, an evaporator 6, an expansion device 8, and a compressor 10 connected in the conventional manner in refrigerant flow communication by refrigerant lines so as to form the refrigerant circuit 2. The present invention will also be described herein with respect to a scroll compressor. It is to understood, however, that the present invention may be applied to screw compressors, rotary compressors, centrifugal compressors, reciprocating compressors and any other compressors wherein the compression elements are driven by a drive shaft that is typically driven by an AC induction motor.

Referring now to FIG. 2, there is depicted therein a scroll compressor 10 having a compression mechanism 22. The scroll compressor 10 includes a suction inlet 30 and a discharge outlet 32. Refrigerant from a suction line 34, which forms part of the refrigerant circuit 2 and is connected to an upstream component of the air conditioning or refrigeration system, typically an evaporator 6, enters the compressor 10 through the suction inlet 30 and passes to the compression mechanism 22. Compressed refrigerant leaves the compression mechanism 22 through the discharge port 36 and passes out of the compressor 10 through discharge outlet 32 into a discharge line 40 through which the compressed refrigerant is delivered to a downstream component, typically a condenser 4, of the air conditioning or refrigeration system.

The compression mechanism 22 includes an orbiting scroll member 26 and a non-orbiting scroll member 28. The scroll members 26 and 28 have respective wraps 27 and 29 extending outwardly from their respective bases. The wraps 27 and 29 interfit in a conventional manner to define compression pockets therebetween to entrap volumes of fluid during the compression process. The orbiting scroll member 26 is operatively mounted to a drive shaft 25 in a conventional manner. The drive shaft 25 is driven in rotation in a forward direction by the drive motor 24 upon providing electrical power to the drive motor 24. In response to the rotation of the drive shaft 25 in the forward direction, the orbiting scroll member 26 moves in an orbital movement relative to the non-orbiting scroll member 28. The orbital action of the orbiting scroll member 26 displaces the refrigerant spirally inward through the compression pockets formed between the interfitting scroll members 26 and 28 of the compression mechanism 22 to the discharge outlet 32, while progressively reducing the volume of the compression pockets thereby compressing the fluid trapped therein.

The drive motor 24 comprises a conventional AC induction motor having a rotor assembly 24 Å and a stator assembly 24B. The stator assembly includes a plurality of steel laminations forming poles around which cooper wire is wound to form the primary windings of the motor. The primary windings are connected to a source 5 of alternating current. The stator assembly 24B is disposed coaxially about and in spaced relationship to a rotor assembly 24A. The rotor assembly includes a steel core in the form of an elongated shaft 25A about which is disposed a cylindrical assembly of laminations arranged parallel to the axis of the core shaft, commonly referred to as a squirrel cage, about which copper wire is wound to form the secondary windings of the motor. A motor controller 50 is provided in operative association with the drive motor 24 and controls operation of the drive motor 24 in response to commands received from a system controller 60 associated with the air conditioning or refrigerating system in which the compressor is installed.

The shaft 25A of the rotor assembly 24A of the motor 24 forms a proximal portion of the compressor drive shaft 25. The orbiting scroll member 26 is operatively mounted to a distal portion 25B of the drive shaft 25 in a conventional manner. Thus, the drive shaft 25 includes the rotor shaft 25A as an integral part thereof. In such an arrangement, the rotational speed of compressor drive shaft 25 is the same as the rotational speed of the core shaft of the motor 24. Typically, whether the compressor is a scroll compressor, as depicted herein, a screw compressor, a rotary compressor, centrifugal compressor or a reciprocating compressor, the compressor drive shaft is an integral extension of the rotor core shaft.

When AC current passes through the primary windings of the stator assembly 24B of the AC induction motor 24, a rotating magnetic field is produced. The magnetic flux from the rotating magnetic field induces a current in the secondary windings. This induced current passing through the secondary windings of the rotor assembly 24A produces a second magnetic field. These magnetic fields interact to produce a torque on the rotor assembly 24A causing the shaft 25 to rotate. In AC induction motors, the speed of rotation of the first magnetic field formed in the stator assembly 24B is determined by the frequency of the AC current supply. In operation, the speed at which the rotor shaft 25A rotates will lag the speed of the first magnetic field. The differential in speed of rotation between the first magnetic field and the rotor shaft 25A is commonly referred to as the slip, S, of the motor.

Customarily, with respect to induction motors, the slip is defined by the following relationship:

S=((nₛ−n)/nₛ)*100, where

nₛ=synchronous speed, i.e. the frequency of the AC voltage supplied to the stator,
n=actual shaft speed, i.e. rotational speed of the shaft 25A.
As the load torque on the shaft 25 increases, the actual shaft running speed decreases. Thus, slip increases as the load torque increases.

In accordance with one aspect of the present invention, the magnitude of the slip exhibited by the drive motor 24 is determined and used in control of the operation of the compressor to prevent damage to the motor 24 or other internal compressor components. The measurement of slip can also be used for estimation of power consumed by the motor. For example, when the slip, S, as calculated by the aforementioned relationship, exceeds a predetermined maximum acceptable slip, S_{MAX}, the system controller 60 will cause the load on the compressor to be reduced such that the actual slip exhibited by the motor 24 returns to a level below S_{MAX}. When the slip, S, as calculated by the aforementioned relationship, falls below a predetermined minimum acceptable slip, S_{MIN}, the system controller 60 will cause the load on the compressor to be increased such that the actual slip exhibited by the motor 24 returns to a level above S_{MIN}. If the calculated slip falls within the range from S_{MIN} to S_{MAX}, the controller 60 typically will take no action to adjust the operating load of the compressor, unless performance optimization is desired. In another instances, if the slip exceeds a certain predetermined value, some other operational parameters that affect motor operation can be changed to alleviate the problem associated with slip value exceeding that value. For example, the magnitude of voltage supplied to the motor can be increased or the frequency of the supplied current changed. What is important is that the ability to determine the slip will result in certain corrective actions taken to alleviate the problem associated with the slip being outside certain specified limits set for the operating condition of the motor.

To calculate the magnitude of the slip, S, in accord with the aforementioned relationship, the actual running speed of the drive shaft 25 of the compressor must be determined and the frequency of the electric current powering the motor 24 must be measured. The frequency of the electric current powering the motor 24 is generally the line frequency and may be readily determined through conventional frequency measurement devices, such as a multimeter or power analyzer or may be known beforehand.

The running speed of the drive shaft 25 may be sensed either directly or indirectly. For example, a discharge pressure transducer 52 may be installed in the compressor discharge line 40 near the outlet of the compressor 10 to monitor the actual discharge pressure pulsations. The transducer 52 sends a signal representative of the discharge pressure pulsations to the system controller 60. The system controller 60 monitors this signal and detects the pulsation frequency exhibited by the discharge pressure pulsation measurements. The pulsation frequency will exhibit a component that represents the actual running speed of the drive shaft 25.

Another means for detecting the actual running speed of the shaft 25 is a vibration type sensor. For example, an accelerometer transducer 54 may be installed on the housing of the compressor 10 or on associated piping, such as the suction inlet line or the discharge line, adjacent the compressor 10, to sense the vibration frequency of the compressor. The transducer 54 sends a signal representative of the vibration frequency spectrum to the system controller 60. The system controller 60 monitors this vibration signal and detects a characteristic (fundamental) harmonic exhibited by the frequency signal that represents the actual running speed of the shaft 25. It would also be possible to install a sensor 56, such as for example a proximity probe or a photonic (light) sensor, in association with one of the rotating elements that can measure the speed directly.

Knowing the magnitude of the actual running speed of the shaft 25 and the frequency of the electric power driving the motor 24, the system controller 60 will calculate the actual real-time slip exhibited by the motor 24 in accord with the aforementioned relationship and compare the actual slip with the predetermined acceptable limits on slip, that is S_{MAX} and S_{MIN}, and, if the actual slip, S, lies outside of the acceptable range from S_{MIN} to S_{MAX}, takes corrective action by appropriately adjusting the load on the compressor 10.

Adjusting the load on the compressor in response to the determined magnitude of the slip may be accomplished in various ways. For example, if the compressor 10 is equipped with a variable speed or stepped speed drive, the motor controller 50 may include an inverter for varying the operating frequency or voltage of the power supplied to the compressor motor 24 thereby varying the running speed of the drive shaft 25. If the actual slip is too high, the motor controller 50 would reduce the speed of the drive shaft 25 thereby reducing the load on the compressor 10. Also the strength of the motor can be adjusted by, for example, increasing the magnitude of voltage supplied to the motor. Conversely, is the actual slip is too low, the motor controller 50 would increase the speed or decrease voltage supplied to the motor thereby changing the load on the compressor 10 or adjusting the effective strength of the motor by changing the supplied voltage.

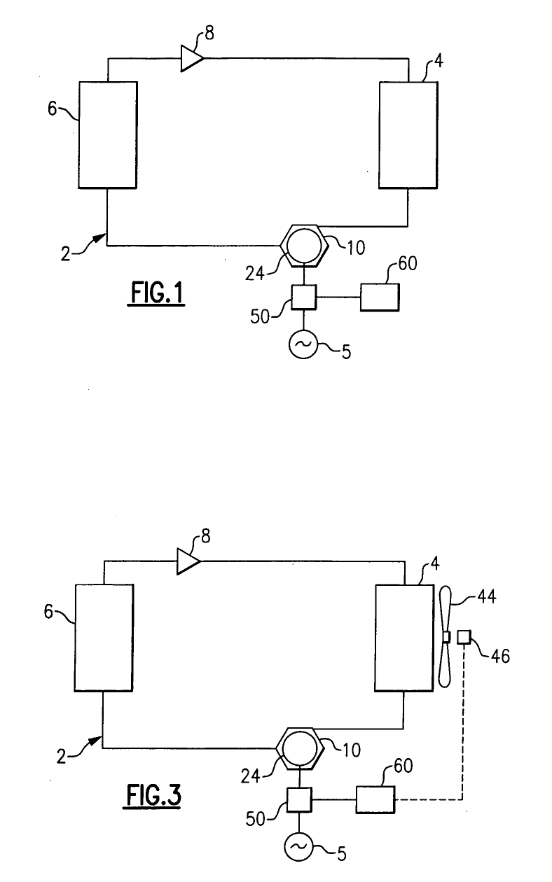

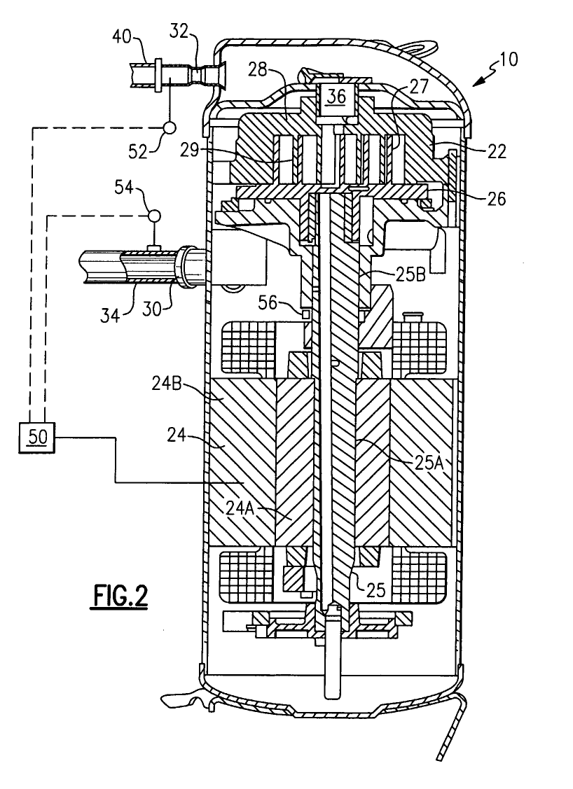

If the compressor 10 is equipped with a constant speed motor, but the condenser has a condenser fan 44 driven by a variable speed or multi-speed motor 46, as illustrated in FIG. 3, the load on the compressor 10 may be adjusted by varying the speed of the condenser fan 44. If the actual slip is too high, the system controller 60 would increase the speed of the condenser fan 44 thereby reducing the load on the compressor 10. Conversely, is the actual slip is too low, the system controller 60 would decrease the speed of the condenser fan 44 increasing the load on the compressor 10. An analogous logic can be executed when multiple single speed condenser fans are provided with the unit. In this case, a number of condenser fans operating simultaneously may be increased or reduced when desired.

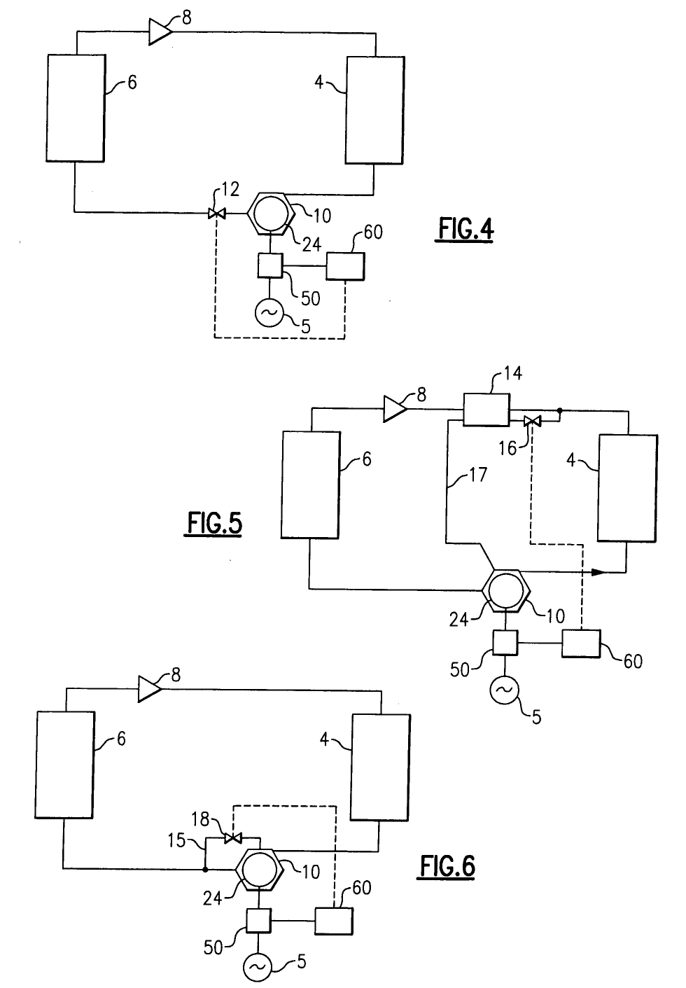

In air conditioning or refrigeration systems equipped with a constant speed compressor, a suction modulation valve 12 may be installed in the suction line upstream of the suction inlet to the compressor 10 as illustrated in FIG. 4. In a system equipped with a suction modulation valve 12, the load on the compressor 10 may be adjusted by controlling the flow rate of fluid to the suction inlet of the compressor 10. If the actual slip is too high, the system controller 60 will modulate the suction modulation valve 12 to decrease the flow rate of fluid to the suction inlet of the compressor 10. Conversely, if the actual slip is too low, the system controller 60 will modulate the suction modulation valve 12 to increase the flow rate of fluid to the suction inlet of the compressor 10.

In many refrigeration systems, an economizer heat exchanger 14 is provided along with an economizer vapor line 17 and auxiliary expansion device 16 to provide for selective injection of refrigerant from the economizer heat exchanger 14 into an intermediate compression stage of the compression mechanism of the compressor 10 as illustrated in FIG. 5. In case the auxiliary expansion device 16 is not equipped with the shutoff function, a separate shutoff flow control device may be needed. In an economized refrigeration system, the load on the compressor 10 may be significantly greater when refrigerant vapor from the economizer is being injected into the compressor 10, then when no vapor injection is occurring. Accordingly, if the actual slip is too high, the system controller 60 will close the valve 16 (partially or completely) to switch from economized operation, i.e. vapor injection occurring, to non-economized operation, i.e. no vapor injection, to reduce the load on the compressor 10. Conversely, if the actual slip is lower than desired, the system controller 60 will open the expansion device 16 to switch over to economized operation, thereby increasing load on the compressor 10.

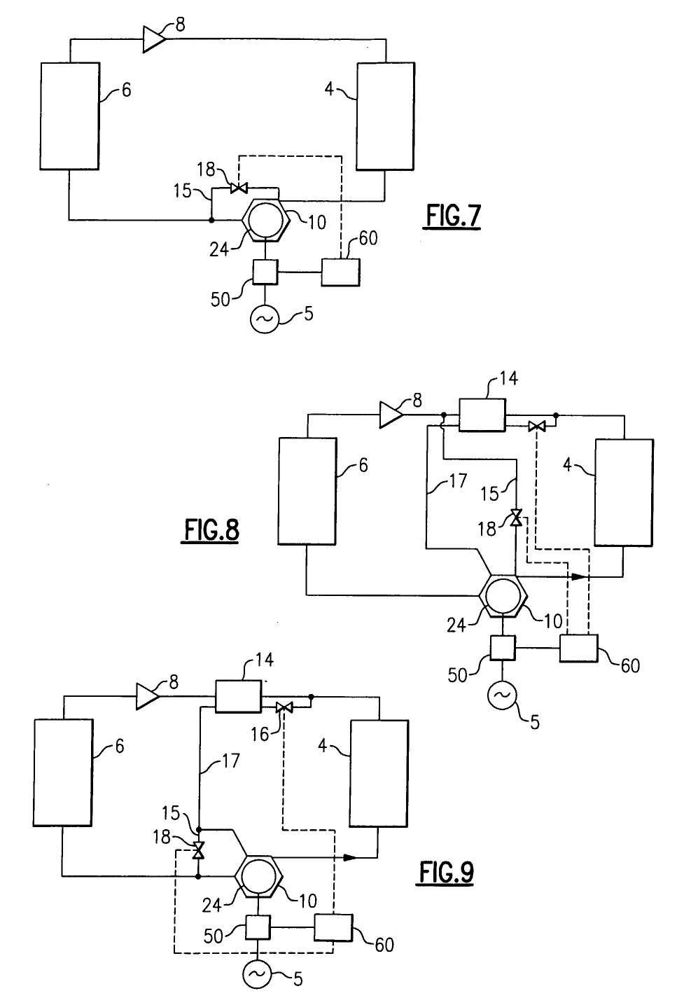

Referring now to FIGS. 6, 7, 8 and 9, in some air conditioning and refrigeration systems, a bypass line 15 and an associated bypass flow control valve 18 may be provided. In such systems, the system controller may selectively open the bypass flow control valve 18 to redirect a portion of the refrigerant to reduce the load on the compressor. For example, in the embodiment illustrated in FIG. 6, refrigerant may be selectively bypassed from an intermediate stage of the compressor 10 back to the suction side of the compressor through bypass line 15, thereby bypassing the evaporator 6. Although illustrated as an external bypass line 15 from an intermediate stage of the compressor 10 back to the suction line adjacent the suction inlet to the compressor 10, it is to be understood that the by-pass may be provided internally within the compressor 10 from an intermediate compression stage of the compression mechanism directly to a suction region within the compressor. In the embodiment illustrated in FIG. 7, refrigerant may be selectively bypassed from the discharge side of the compressor 10 back to the suction side of the compressor 10 through bypass line 15, thereby bypassing the evaporator 6. In the embodiment illustrated in FIG. 8, refrigerant may be selectively bypassed from the discharge side of the compressor 10 directly to the outlet side of the economizer 14 through bypass line 15 thereby bypassing the condenser 4. In the embodiment illustrated in FIG. 9, refrigerant may be selectively bypassed from the outlet side of the economizer 14 through bypass line 15 back to the suction side of the compressor 10 thereby passing the evaporator 6. If the compressor is a reciprocating compressor, reducing the load on the compressor may be accomplished by unloading at least one cylinder of the reciprocating compressor.

Although the present invention has been described and illustrated with respect to the afore-described embodiments, other embodiments will occur to those skilled in the art. For example, alternate techniques to adjust compressor power, such as indoor fan speed adjustment or other adjustments, may be exercised to prevent compressor damage or improve its reliability. As noted hereinbefore, although described with reference to a compressor in a vapor compression system, those skilled in art will recognize that the present invention may be applied to any device under a load that is driven by an AC induction motor. It is therefore intended that the scope of the present invention is to be limited only by the scope of the appended claims.

What is claimed is:

1. A method of operating an AC induction motor powered by electric current from an AC source at a frequency and a voltage, said AC motor having a rotor shaft and exhibiting a slip under load approximately proportional to the load, said method comprising the steps of:
determining the magnitude of the slip exhibited by the motor under load; and
taking corrective action to modify the motor operation based on the magnitude of the slip.

2. A method as recited in claim 1 wherein the step of taking corrective action to modify the motor operation based on the magnitude of the slip comprises adjusting the load on the motor.

3. A method as recited in claim 1 wherein the step of taking corrective action to modify the motor operation based on the magnitude of the slip comprises adjusting the frequency of the electric current from the AC source powering the motor.

4. A method as recited in claim 1 wherein the step of taking corrective action to modify the motor operation based on the magnitude of the slip comprises adjusting the voltage of the electric current from the AC source powering the motor

5. A method as recited in claim 1, wherein the step of:
determining the magnitude of the slip exhibited by the motor under load:
determining the actual running speed of the rotor shaft;
measuring the frequency of the electric current powering the motor; and
calculating the magnitude of the slip based on the actual running speed of the rotor shaft and the frequency of the electric current powering the motor.

6. A method as recited in claim 5, wherein the step of calculating the magnitude of the slip comprises calculating the magnitude of the slip using the relationship:
S=((nₛ−n)/nₛ)*100, where
nₛ=the frequency of the AC source supplied to the motor,
n=actual running speed of the rotor shaft.

7. A method of operating a compressor under a load, the compressor having a driven shaft operatively associated with a compression mechanism wherein fluid is compressed upon rotation of the driven shaft and an AC induction motor operatively associated with the driven shaft for driving the driven shaft, the AC induction motor powered by electric current from an AC source, the AC induction motor exhibiting a slip approximately proportional to the load, said method comprising the steps of:
determining the magnitude of the slip exhibited by the motor under the load on the compressor; and
taking corrective action to modify the motor operation based on the magnitude of the slip.

8. A method of operating a compressor as recited in claim 7 wherein the step of taking corrective action to modify the motor operation based on the magnitude of the slip comprises adjusting the load on the compressor in response to the determined magnitude of the slip.

9. A method of operating a compressor as recited in claim 7, wherein the step of taking corrective action to modify the motor operation based on the magnitude of the slip comprises:
comparing the determined magnitude of the slip to a preselected range of desired magnitudes for slip having an upper limit and a lower limit; and
if the determined magnitude of the slip is greater than the preselected upper limit of the range of desired magnitudes for slip, decreasing the load on the compressor, and if the determined magnitude of the slip is less than the preselected lower limit of the range of desired magnitudes for slip, increasing the load on the compressor.

10. A method of operating a compressor as recited in claim 7, wherein the step of
determining the magnitude of the slip exhibited by the motor under the load on the compressor comprises:
determining the actual running speed of the drive shaft of the compressor;
measuring the frequency of the electricity powering the motor; and
calculating the magnitude of the slip based on the actual running speed of the drive shaft and the frequency of the electricity powering the motor.

11. A method of operating a compressor as recited in claim 10, wherein the step of calculating the magnitude of the slip comprises calculating the magnitude of the slip using the relationship:
S=((nₛ−n)/nₛ)*100, where
nₛ=the frequency of the AC source supplied to the motor,
n=actual running speed of the compressor drive shaft.

12. A method of operating a compressor as recited in claim 10 wherein the step of determining the actual running speed of the compressor drive shaft comprises monitoring pulsations of the discharge pressure.

13. A method of operating a compressor as recited in claim 10 wherein the step of determining the actual running speed of the compressor drive shaft comprises monitoring vibrations exhibited by said compressor or by any piping associated with said compressor.

14. A method of operating a compressor as recited in claim 8 wherein said compressor is operationally a component of a vapor compression system including a condenser fan, and the step of adjusting the load on the compressor in response to the determined magnitude of the slip comprises adjusting the speed of the condenser fan in response to the determined magnitude of the slip.

15. A method of operating a compressor as recited in claim 8 wherein said compressor is operationally a component of a vapor compression system including an economizer and an associated vapor injection system for selectively injecting vapor flow into said compressor, and the step of adjusting the load on the compressor in response to the determined magnitude of the slip comprises adjusting the vapor flow injected into said compressor in response to the determined magnitude of the slip.

16. A method of operating a compressor as recited in claim 8 wherein said compressor is operationally a component of a vapor compression system including a suction modulation valve for modulating the flow of fluid into said compressor, and wherein the step of adjusting the load on the compressor in response to the determined magnitude of the slip comprises adjusting the suction modulation valve in response to the determined magnitude of the slip.

17. A method of operating a compressor as recited in claim 8 wherein said compressor is operationally a component of a vapor compression system, and wherein the step of adjusting the load on the compressor in response to the determined magnitude of the slip comprises bypassing a portion of the fluid from one of a discharge side of the compressor or an intermediate stage of the compressor to a suction side of the compressor.

18. A method of operating a compressor as recited in claim 8 wherein said compressor is operationally a component of a vapor compression system including an economizer operatively associated with said compressor, and wherein the step of adjusting the load on the compressor in response to the determined magnitude of the slip comprises bypass a portion of the fluid from a discharge side of the compressor to the economizer.

19. A method of operating a compressor as recited in claim 8 wherein said compressor is operationally a component of a vapor compression system including an economizer operatively associated with said compressor, and wherein the step of adjusting the load on the compressor in response to the determined magnitude of the slip comprises bypass a portion of the fluid from the economizer to a suction side of the compressor.

20. A method of operating a compressor as recited in claim 8 wherein said compressor is a reciprocating compressor, and wherein the step of adjusting the load on the compressor in response to the determined magnitude of the slip comprises unloading at least one cylinder of said compressor.

21. A vapor compression system comprising:
a compressor having a driven shaft operatively associated with a compression mechanism wherein fluid is compressed upon rotation of the driven shaft;
an AC induction motor operatively associated with the driven shaft for driving the driven shaft, the AC induction motor powered by electric current from an AC source, the AC induction motor exhibiting a slip approximately proportional to the load;
a sensor operatively associated with the compressor for determining the magnitude of the slip exhibited by the motor when driving the driven shaft; and
a controller operatively associated with said motor for taking corrective action to modify the motor operation based on the magnitude of the slip.

22. A vapor compression system as recited in claim 21 wherein the compressor is a variable speed compressor.

23. A vapor compression system as recited in claim 21 wherein the compressor is a multi-speed compressor.

24. A vapor compression system as recited in claim 21 further comprising:
a sensor for determining the actual running speed of the drive shaft of the compressor; and
a sensor for measuring the frequency of the electricity powering the motor.

25. A vapor compression system as recited in claim 24 wherein said sensor for determining the actual running speed of the drive shaft of the compressor comprises a pressure transducer.

26. A vapor compression system as recited in claim 24 wherein said sensor for determining the actual running speed of the drive shaft of the compressor comprises a proximity probe.

27. A vapor compression system as recited in claim 24 wherein said sensor for determining the actual running speed of the drive shaft of the compressor comprises a photonic sensor.

28. A vapor compression system as recited in claim 24 wherein said sensor for determining the actual running speed of the drive shaft of the compressor comprises an accelerometer.
